(19) United States
(12) Patent Application Publication
(10) Pub. No.: US 2025/0142308 A1
(43) Pub. Date: May 1, 2025

(54) EMERGENCY MESSAGING USING MOBILE RELAY

(71) Applicant: QUALCOMM INCORPORATED, San Diego, CA (US)

(72) Inventors: Kangqi Liu, San Diego, CA (US); Alexei Yurievitch Gorokhov, San Diego, CA (US); Ruiming Zheng, Beijing (CN); Qiaoyu Li, Beijing (CN); Hao Xu, Beijing (CN); Chao Wei, Beijing (CN); Mingxi Yin, Beijing (CN)

(21) Appl. No.: 18/837,160

(22) PCT Filed: Apr. 20, 2022
(86) PCT No.: PCT/CN2022/087863

§ 371 Date: Aug. 8, 2024

(51) Int. Cl. H04W 4/90; H04B 7/185; H04W 84/06; H04W 88/04

(52) U.S. Cl. CPC H04W 4/90; H04B 7/1851; H04W 84/06; H04W 88/04

(57) ABSTRACT

Methods, systems, and devices for wireless communications are described. Some wireless communications systems may support emergency messaging using a mobile relay. For example, a first user equipment (UE), may transmit a first emergency message indicating a request for relaying a second emergency message to one or more network entities, the first UE being out-of-coverage of a network entity. The first UE may receive, from a second UE associated with an aircraft, a feedback message in response to the first emergency message and may transmit, to the second UE, a second emergency message based on receiving the feedback message. The second UE may receive the second emergency message and transmit, over an air-to-ground wireless communications network, an indication based on the first emergency message and the second emergency message.

### CROSS REFERENCE

The present Application is a 371 national stage filing of International PCT Application No. PCT/CN2022/087863 by Liu et al. entitled “EMERGENCY MESSAGING USING MOBILE RELAY,” filed Apr. 20, 2022, which is assigned to the assignee hereof, and which is expressly incorporated by reference in its entirety herein.

### FIELD OF TECHNOLOGY

The following relates to wireless communications, including emergency messaging using mobile relay.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support emergency messaging using mobile relay. Generally, the described techniques provide for a first user equipment (UE) that is outside the coverage area of a network entity (e.g., does not have cellular coverage), to transmit emergency messages to a second UE for relaying to a network entity. For example, the first UE may broadcast, according to a beam sweeping procedure, a first emergency message indicating a request for relaying a second emergency message to one or more network entities. The second UE, which may be associated with an aircraft, may receive the first emergency message and transmit a feedback message in response to first emergency message. In some cases, the feedback message may include an indication that the second UE is in communication with or capable of communicating with a network entity over an air-to-ground (ATG) wireless communications network, an indication of a set of resources for transmitting the second emergency message, or both. The first UE may receive the feedback message and may unicast the second emergency message to the second UE (e.g., via the indicated set of resources) based on receiving the feedback message. The second UE may receive the second emergency message and transmit an indication of the first emergency message, the second emergency message, or both, to a network entity.

In some cases, the second UE may transmit the indication directly to the network entity while, in some other cases, the second UE may transmit the indication to a third UE and the third UE may transmit the indication to the network entity. Additionally, the second UE may transmit a second feedback message to the first UE based on receiving the second emergency message and the first UE may refrain from transmitting additional emergency messages based on the second feedback message.

A method for wireless communications at a first UE is described. The method may include transmitting a first emergency message indicating a request for relaying a second emergency message to one or more network entities, the first UE being out-of-coverage of a network entity, receiving, from a second UE associated with an aircraft, a feedback message in response to the transmitting of the first emergency message, and transmitting, to the second UE, the second emergency message based on the receiving of the feedback message.

An apparatus for wireless communications at a first UE is described. The apparatus may include a processor, memory coupled with the processor, and instructions stored in the memory. The instructions may be executable by the processor to cause the apparatus to transmit a first emergency message indicating a request for relaying a second emergency message to one or more network entities, the first UE being out-of-coverage of a network entity, receive, from a second UE associated with an aircraft, a feedback message in response to the transmitting of the first emergency message, and transmit, to the second UE, the second emergency message based on the receiving of the feedback message.

Another apparatus for wireless communications at a first UE is described. The apparatus may include means for transmitting a first emergency message indicating a request for relaying a second emergency message to one or more network entities, the first UE being out-of-coverage of a network entity, means for receiving, from a second UE associated with an aircraft, a feedback message in response to the transmitting of the first emergency message, and means for transmitting, to the second UE, the second emergency message based on the receiving of the feedback message.

A non-transitory computer-readable medium storing code for wireless communications at a first UE is described. The code may include instructions executable by a processor to transmit a first emergency message indicating a request for relaying a second emergency message to one or more network entities, the first UE being out-of-coverage of a network entity, receive, from a second UE associated with an aircraft, a feedback message in response to the transmitting of the first emergency message, and transmit, to the second UE, the second emergency message based on the receiving of the feedback message.

In some examples of the method, apparatuses, and non-transitory computer-readable medium described herein, the receiving of the feedback message may include operations, features, means, or instructions for receiving, in the feedback message, an indication that the second UE may be in communication with the network entity via an ATG wireless communications network.

In some examples of the method, apparatuses, and non-transitory computer-readable medium described herein, the receiving of the feedback message may include operations, features, means, or instructions for receiving, in the feedback message, an indication that the second UE may be capable of communicating with the network entity via an ATG wireless communications network.

Some examples of the method, apparatuses, and non-transitory computer-readable medium described herein may further include operations, features, means, or instructions for receiving, from the second UE, a second feedback message in response to the second emergency message and refraining from transmitting additional emergency messages based on the receiving of the second feedback message.

In some examples of the method, apparatuses, and non-transitory computer-readable medium described herein, the transmitting of the first emergency message may include operations, features, means, or instructions for transmitting the first emergency message according to aircraft information associated with the second UE.

Some examples of the method, apparatuses, and non-transitory computer-readable medium described herein may further include operations, features, means, or instructions for comparing an initial position of the first UE to a current position of the first UE and determining whether the aircraft information may be valid may be based on a difference between the initial position and the current position satisfying a threshold.

Some examples of the method, apparatuses, and non-transitory computer-readable medium described herein may further include operations, features, means, or instructions for receiving, from the network entity, a control message indicating the aircraft information.

Some examples of the method, apparatuses, and non-transitory computer-readable medium described herein may further include operations, features, means, or instructions for receiving, from the network entity, a control message indicating a periodic timer, where the transmitting of the first emergency message may be based on the periodic timer.

In some examples of the method, apparatuses, and non-transitory computer-readable medium described herein, transmitting the first emergency message may include operations, features, means, or instructions for broadcasting the first emergency message via one or more beams.

In some examples of the method, apparatuses, and non-transitory computer-readable medium described herein, a beam sweeping procedure associated with the one or more beams may be non-uniform.

In some examples of the method, apparatuses, and non-transitory computer-readable medium described herein, elevation angles of the one or more beams may be configured to communicate with a flying UE.

Some examples of the method, apparatuses, and non-transitory computer-readable medium described herein may further include operations, features, means, or instructions for receiving, from a third UE that may be out-of-coverage of the network entity, an indication that the third UE received the first emergency message and a request to cooperate with transmitting emergency messages, where the transmitting of the first emergency message may be based on the receiving of the indication.

In some examples of the method, apparatuses, and non-transitory computer-readable medium described herein, the transmitting of the first emergency message may include operations, features, means, or instructions for transmitting the first emergency message according to a periodicity that may be based on the request to cooperate with transmitting emergency messages.

Some examples of the method, apparatuses, and non-transitory computer-readable medium described herein may further include operations, features, means, or instructions for receiving, from a third UE, a second feedback message in response to the transmitting of the first emergency message and transmitting, to the third UE, the second emergency message based on the receiving of the second feedback message.

In some examples of the method, apparatuses, and non-transitory computer-readable medium described herein, the first emergency message, the second emergency message, or both, include identification information for the first UE.

In some examples of the method, apparatuses, and non-transitory computer-readable medium described herein, the first emergency message may be transmitted via a set of broadcast resources that may be based on one or more parameters at the first UE, the network entity, a satellite entity, or any combination thereof.

In some examples of the method, apparatuses, and non-transitory computer-readable medium described herein, the second emergency message may be transmitted via a set of resources that may be based on the feedback message, one or more parameters at the first UE, the network entity, or a satellite entity, or any combination thereof.

In some examples of the method, apparatuses, and non-transitory computer-readable medium described herein, the first UE communicates with the second UE via a sidelink interface.

A method for wireless communications at a first UE is described. The method may include receiving, from a second UE, a first emergency message indicating a request for relaying a second emergency message to an entity, transmitting, to the second UE, a feedback message in response to the receiving of the first emergency message, receiving, from the second UE, the second emergency message based on the transmitting of the feedback message, and transmitting an indication over an ATG wireless communications network, the indication based on the first emergency message and the second emergency message.

An apparatus for wireless communications at a first UE is described. The apparatus may include a processor, memory coupled with the processor, and instructions stored in the memory. The instructions may be executable by the processor to cause the apparatus to receive, from a second UE, a first emergency message indicating a request for relaying a second emergency message to an entity, transmit, to the second UE, a feedback message in response to the receiving of the first emergency message, receive, from the second UE, the second emergency message based on the transmitting of the feedback message, and transmit an indication over an ATG wireless communications network, the indication based on the first emergency message and the second emergency message.

Another apparatus for wireless communications at a first UE is described. The apparatus may include means for receiving, from a second UE, a first emergency message indicating a request for relaying a second emergency message to an entity, means for transmitting, to the second UE, a feedback message in response to the receiving of the first emergency message, means for receiving, from the second UE, the second emergency message based on the transmitting of the feedback message, and means for transmitting an indication over an ATG wireless communications network, the indication based on the first emergency message and the second emergency message.

A non-transitory computer-readable medium storing code for wireless communications at a first UE is described. The code may include instructions executable by a processor to receive, from a second UE, a first emergency message indicating a request for relaying a second emergency message to an entity, transmit, to the second UE, a feedback message in response to the receiving of the first emergency message, receive, from the second UE, the second emergency message based on the transmitting of the feedback message, and transmit an indication over an ATG wireless communications network, the indication based on the first emergency message and the second emergency message.

In some examples of the method, apparatuses, and non-transitory computer-readable medium described herein, the first UE communicates with the second UE via a sidelink interface.

In some examples of the method, apparatuses, and non-transitory computer-readable medium described herein, receiving the first emergency message may include operations, features, means, or instructions for receiving the first emergency message in a broadcast transmission.

In some examples of the method, apparatuses, and non-transitory computer-readable medium described herein, transmitting the feedback message may include operations, features, means, or instructions for transmitting, in the feedback message, an indication of resources for transmitting the second emergency message.

In some examples of the method, apparatuses, and non-transitory computer-readable medium described herein, receiving the second emergency message may include operations, features, means, or instructions for receiving, in the second emergency message, identification information for the second UE.

In some examples of the method, apparatuses, and non-transitory computer-readable medium described herein, receiving the first emergency message may include operations, features, means, or instructions for receiving the first emergency message via one or more beams.

Some examples of the method, apparatuses, and non-transitory computer-readable medium described herein may further include operations, features, means, or instructions for transmitting a second feedback message in response to the second emergency message.

In some examples of the method, apparatuses, and non-transitory computer-readable medium described herein, transmitting the indication may include operations, features, means, or instructions for transmitting the indication to a network entity, a satellite entity, a third UE, or any combination thereof.

### BRIEF DESCRIPTION OF THE DRAWINGS

FIGS. 1, 2, and 3 illustrate examples of wireless communications systems that support emergency messaging using mobile relay in accordance with one or more aspects of the present disclosure.

FIG. 4 illustrates an example of a cooperative emergency messaging process that supports emergency messaging using mobile relay in accordance with one or more aspects of the present disclosure.

FIG. 5 illustrates an example of a process flow that supports emergency messaging using mobile relay in accordance with one or more aspects of the present disclosure.

FIGS. 6 and 7 show block diagrams of devices that support emergency messaging using mobile relay in accordance with one or more aspects of the present disclosure.

FIG. 8 shows a block diagram of a communications manager that supports emergency messaging using mobile relay in accordance with one or more aspects of the present disclosure.

FIG. 9 shows a diagram of a system including a device that supports emergency messaging using mobile relay in accordance with one or more aspects of the present disclosure.

FIGS. 10 through 13 show flowcharts illustrating methods that support emergency messaging using mobile relay in accordance with one or more aspects of the present disclosure.

### DETAILED DESCRIPTION

Some wireless communications systems may support emergency (e.g., SOS) messaging from a user equipment (UE), such as a terrestrial UE. For example, the terrestrial UE may support emergency messaging with an aircraft UE communicating over an air-to-ground (ATG) wireless communication node when the terrestrial UE is out of the cellular coverage area of a network entity (e.g., the terrestrial UE does not have cellular coverage). That is, the terrestrial UE may transmit an emergency message to the aircraft UE and the aircraft UE may relay the emergency message to a network entity. In some cases, to initiate communications with the terrestrial UE, the aircraft UE may transmit discovery signaling. However, transmitting the discovery signaling may result in interference with terrestrial communications. In some other cases, the terrestrial UE may transmit repetitions of the emergency message for the aircraft UE to receive. However, signaling repetitions of an emergency message by the terrestrial UE may result in increased power consumption at the terrestrial UE.

Techniques described herein may support a two-part emergency messaging using mobile relay. For example, a first UE may broadcast a first emergency message indicating a request for relaying a second emergency message to a network entity. A second UE (e.g., a relay node) may receive the first emergency message and transmit a feedback message in response to the first emergency message indicating that the second UE is available to relay the second emergency message. In some cases, the feedback message may include an indication that the second UE may relay the second emergency message over an ATG wireless communications network. Additionally, or alternatively, the feedback message may include an indication of resources for transmitting the second emergency message. The first UE may receive the feedback message and unicast the second emergency message to the second UE (e.g., via the indicated resources). The second UE may receive the second emergency message and relay an indication of an emergency message (e.g., the first emergency message, the second emergency message, or both) to a network entity, either directly or via additional UEs (e.g., relay nodes).

Aspects of the disclosure are initially described in the context of wireless communications systems. Aspects of the disclosure are then described in the context of a cooperative emergency messaging process and a process flow. Aspects of the disclosure are further illustrated by and described with reference to apparatus diagrams, system diagrams, and flowcharts that relate to emergency messaging using mobile relay.

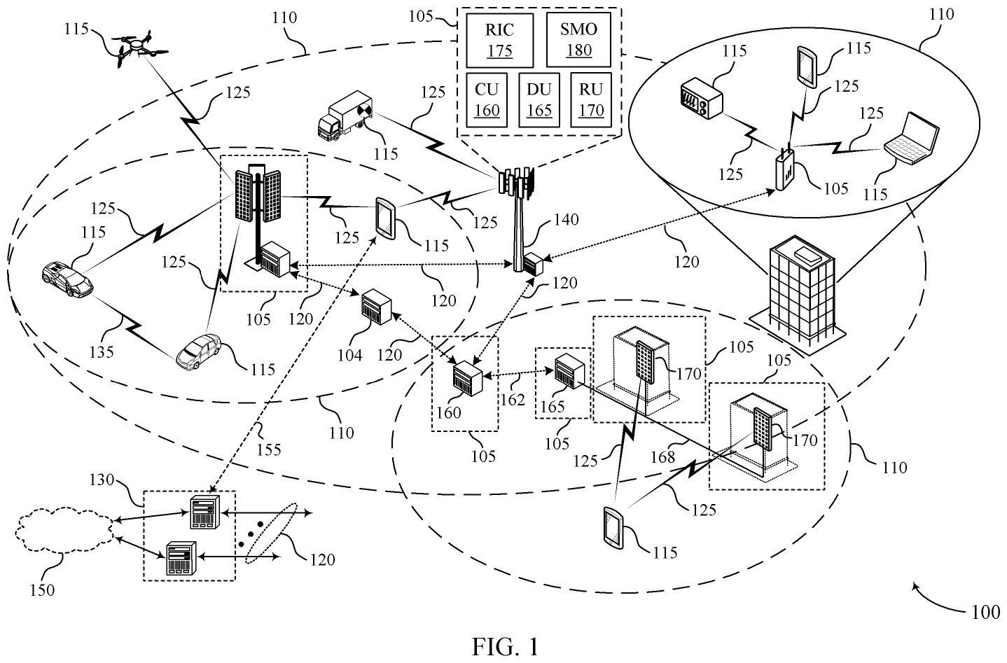

FIG. 1 illustrates an example of a wireless communications system 100 that supports emergency messaging using mobile relay in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support emergency messaging using mobile relay as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving.” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below: 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

The wireless communications system 100 may support a two-part emergency message using mobile relay as described herein. For example, a first UE 115 (e.g., terrestrial UE) may be outside of cellular coverage of a terrestrial-based network entity and may broadcast a first emergency message indicating a request to relay a second emergency message to a network entity. A second UE 115 may receive the first emergency message and may transmit a first feedback message to the first UE 115 based on receiving the first emergency message. In some cases, the first feedback message may include an indication that the second UE 115 is available for relaying messages, the second UE 115 is capable of communicating over an ATG wireless communications network, an indication of resources for the second emergency message, or any combination thereof. The first UE 115 may receive the first feedback message and may unicast the second emergency message to the second UE 115. The second UE 115 may receive the second emergency message and transmit an indication of an emergency message (e.g., the first emergency message, the second emergency message, or both) to a network entity 105, either directly or via one or more additional UEs 115 (e.g., relay nodes). In some cases, the second UE 115 may transmit a second feedback message to the first UE 115 indicating that the second UE 115 received the second emergency message (e.g., and is relaying or has relayed the indication of the emergency message to the network entity) and the first UE 115 may refrain from transmitting additional emergency messages (e.g., the first emergency message, the second emergency message, or both) based on receiving the second feedback message.

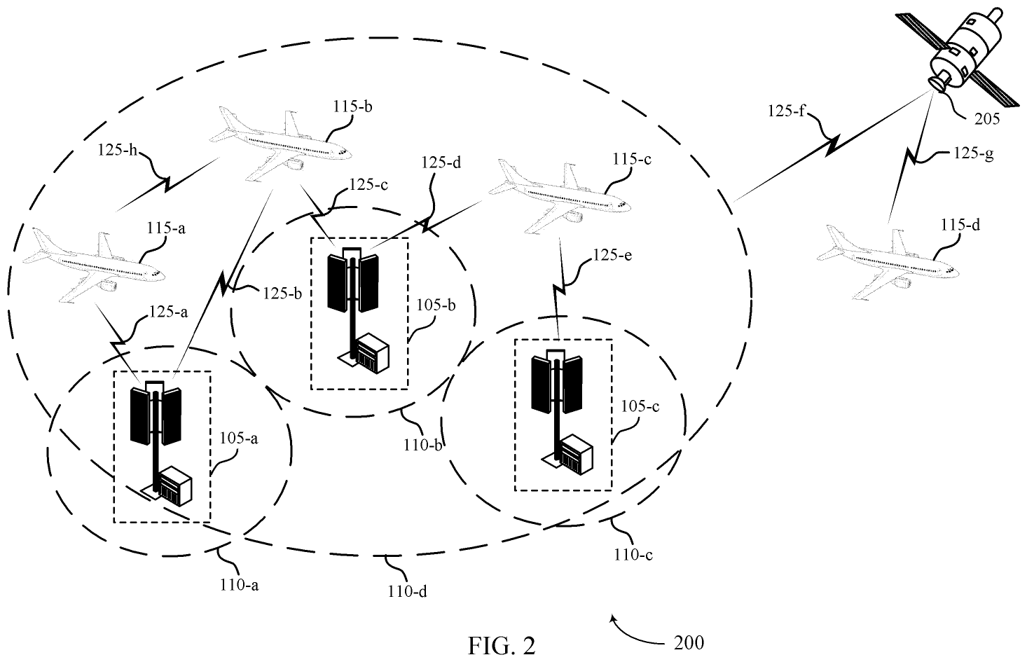

FIG. 2 illustrates an example of a wireless communications system 200 that supports emergency messaging using mobile relay in accordance with one or more aspects of the present disclosure. The wireless communications system 200 may implement or be implemented by aspects of the wireless communications system 100 as described with reference to FIG. 1. For example, the wireless communications system 200 may include a network entity 105-a, a network entity 105-b, and a network entity 105-c which may represent examples of network entities 105 as described herein, including with reference to FIG. 1. Additionally, the wireless communications system 200 may include a UE 115-a, a UE 115-b, a UE 115-c, and a UE 115-d which may represent examples of UEs 115 as described herein, including with reference to FIG. 1.

The network entities 105 may each correspond to a coverage area 110, such as a coverage area 110-a, a coverage area 110-b, and a coverage area 110-c, which may be examples of coverage areas 110 as described herein with reference to FIG. 1. For example, the network entity 105-a may serve a coverage area 110-a, the network entity 105-b may serve a coverage area 110-b, and the network entity 105-c may serve a coverage area 110-c. The network entities 105 may communicate with UEs 115 via one or more communication links 125, such as a communication link 125-a, a communication link 125-b, a communication link 125-c, a communication link 125-d, a communication link 125-e, a communication link 125-f, and a communication link 125-g, which may represent examples of communication links 125 as described herein with reference to FIG. 1. In some examples, the UEs 115 may be examples of airplanes or other wireless devices (e.g., drones, vehicles, or other examples of wireless communications devices).

The wireless communications system 200 may support various types of communications, such as ATG communications. For example, in an in-land or coastal area, the network entity 105-a (e.g., a gNB, such as an ATG-gNB) may be on the ground and transmit communications via an antenna that is tilted up towards the UE 115-a. The UE 115-a may be an example of an ATG-UE and may receive the communications with an antenna pointing down (e.g., the UE 115-a may include antennas at the bottom of the UE 115-a). For example, an antenna of the aircraft UE 115-a may be mounted at a bottom of the aircraft (e.g., antennas with beamforming capabilities). Such wireless communications may be relatively low cost, relatively high throughput, realize lower latency, or any combination thereof, compared to satellite communications with a satellite 205. In some examples, the wireless communications system 200 may support one or more traffic types (e.g., aircraft passenger communications, air traffic management communications, aircraft surveillance or maintenance communications, air traffic control, and the like). In some cases, the one or more traffic types may be present based on the location of the UEs 115 (e.g., in-flight passenger communications present en-route during commercial flights and/or in-flight passenger communications present during takeoff (e.g., climb) and landing (e.g., descent) during business aviation).

Additionally, or alternatively, the wireless communications system 200 may support communications with the satellite 205. For example, the satellite 205 may communicate with the UE 115-d (e.g., in an ocean area where the UE 115-d may be outside the coverage area 110-c associated with the network entity 105-c). The satellite 205 may communicate with devices in the coverage area 110-d. For example, the network entity 105-c may transmit or receive communications with the satellite 205, and the satellite 205 may transmit or receive communications with the UE 115-d via the communication link 125-g.

In some examples, the wireless communications system 200 may support TDD or FDD communications, including FDD communications in a non-terrestrial network (NTN). In some examples, the wireless communications system 200 may support relatively large inter-site distances (ISD), relatively large coverage ranges, or a combination thereof. For example, in order to control the network deployment cost and account for a quantity of flights, a large ISD may be implemented (e.g., 100 kilometers (km), 200 km, or another range). Additionally, or alternatively, the distance between a UE 115 and a network entity 105 may be relatively large (e.g., when a plane is above the sea, the distance may be more than 200 km), and thus the wireless communications system 200 (e.g., an ATG network) may be configured to provide a relatively large cell coverage (e.g., up to 300 km cell coverage).

In some examples, the wireless communications system 200 may support both ATG communications (e.g., an ATG network) and a terrestrial NR network. For example, interference between the terrestrial network and the ATG network may be relatively low and some operators may adopt a same frequency for deploying both networks (e.g., 4.8 GHZ). In some examples, an ATG terminal (e.g., a UE 115) may have a relatively large capacity. For example, an on-board ATG terminal may be relatively more powerful than a mobile device UE 115 (e.g., the terminal may have a higher effective isotropically radiated power (EIRP), larger transmission power, or larger on-board antenna gain than some terrestrial UEs 115).

In some examples, the wireless communications system 200 may support one or more throughput attributes and specifications for NR-ATG communications. In some examples, the wireless communications system 200 may support a data rate per personal device (e.g., 15 megabits-per-second (Mbps) in the downlink and 7.5 Mbps in the uplink), which may also apply to cell-edge devices. In some examples, the wireless communications system 200 may support an end-to-end latency (e.g., 10 milliseconds (ms)). In some examples, the wireless communications system 200 may support a degree of mobility (e.g., up to 1200 km per hour (km/h)) for UEs 115. In some examples, the wireless communications system 200 may support a connection density (e.g., 80 personal devices per aircraft, 60 aircraft per 18,000 square km, or another connection density). In some cases, to enable the connection density, the wireless communications system 200 may support a quantity of sectors per cell (e.g., 3 sectors per cell) where each cell may include a quantity of supported devices (e.g., 20 aircraft). In some examples, the wireless communications system 200 may support a data rate per aircraft (e.g., 1.2 gigabits-per-second (Gbps) in the downlink, and 600 Mbps in the uplink), which may also apply to cell-edge devices. In one example, such aircraft may include 400 passengers, and at a 20% activation factor, and there may be 80 personal devices per aircraft.

In some cases, the wireless communications system 200 may be configured as described herein to support relatively large cell coverage ranges (e.g., up to 300 km), flight speeds (e.g., 1200 km/hour flight speeds), coexistence between ATG networks and terrestrial networks, ATG base station or UE core and performance thresholds, or any combination thereof. For example, the wireless communications system 200 may support a relatively large ISD (e.g., 100 km to 200 km in-land, and up to 300 km coverage along coasts). Additionally, or alternatively, the wireless communications system 200 may support a relatively large timing advance (TA) (e.g., a TA value equal to 2 ms at 300 km of coverage) to avoid frequent handover and inter-cell interference.

Additionally, or alternatively, wireless communications system 200 may support a relatively large per-cell throughput (e.g., a data rate of at least 1 Gbps per aircraft). For example, an aircraft may experience a 1.2 Gbps data rate for downlink communications, and a 600 Mbps data rate for uplink communications. Such large per-cell throughput may occur in airspaces that have a density of 60 aircraft per 18,000 square km, for cell coverage ranges of 134 km. In cases where aircraft or airspace densities are high (e.g., congested, such as around busy airports), data rates may decrease, but may still remain at or above the 1 Gbps data rate per aircraft specification.

Additionally, or alternatively, wireless communications system 200 may support a relatively large Doppler shift in frequency (e.g., a line of sight (LoS) max Doppler shift at 1200 km/h may be about 0.77 kHz at 700 MHz, or 3.89 kHz at 3.5 GHZ, or 5.33 kHz at 4.8 GHz), a relatively large SCS (e.g., an SCS value of 7.5 kHz at 700 MHz, or 30 kHz or 60 kHz at 3.5 GHZ, or 60 kHz at 4.8 GHz, assuming a receiver on a device may tolerate a maximum LoS Doppler shift of about 10 percent of the SCS), a relatively short coherence time, a relatively fast TA drifting, or any combination of these.

Additionally, or alternatively, wireless communications system 200 may support various CP lengths or waveforms. These may support various propagation scenarios such as en-route, climbing, descending, take-off, landing, taxiing, or parking of an aircraft, and the like. In en-route, climbing, and descent propagation scenarios, signals may fade according to a Rician model due to interactions between propagation paths of signals. For example, there may be a signal delay of up to 2.5 km for en-route scenarios, corresponding to an 8.33 microseconds (μs) delay in time. In take-off, landing, taxiing, and parking propagation scenarios, signals may fade according to a Rayleigh model due to interactions between propagation paths of signals. In climbing and descent, or take-off and landing propagation scenarios, or both, a signal delay may be comparable to or less than that of en-route (e.g., still relatively large). Parking and taxi delays may be similar to terrestrial-like delays.

Additionally, or alternatively, wireless communications system 200 may cause interference towards terrestrial NR systems if frequencies are reused. For example, aircraft transmission beam widths may become larger (e.g., after 100 km to 200 km of propagation), affecting a relatively wide terrestrial area. Such interference may be relatively dynamic and non-synchronized when accounting for effects of dynamic TDD and large propagation delays.

The wireless communications system 200 may communicate according to a UAC protocol. In an NR system, a UAC protocol may allow operator devices (e.g., network entities 105, or the like) to control access of subscriber devices (e.g., UEs 115, or the like) to a particular NR system or network. Depending on operator policies, deployment scenarios, subscriber profiles, available services, or any combination of these, operator devices may use different criteria in determining which access attempts by subscriber devices may be allowed or blocked (e.g., when congestion occurs in the NR system or network). These different criteria (e.g., characteristics, time, location, proximity, interference, or any other criteria) may be associated with various access identities, access categories, or both. Thus, operator devices may categorize each access attempt into one or more access identities, access categories, or both. In some cases, an access identity may be associated with a UE 115 subscription type, and an access category may be associated with a UE 115 service (e.g., emergency, voice call, or the like) that may be triggering the access attempt.

The wireless communications system 200 may support a two-part emergency message using mobile relay as described herein. For example, a first UE, such as a terrestrial UE 115, may lose cellular coverage and may broadcast a first emergency message indicating a request to relay a second emergency message to a network entity 105. A second UE 115, such as a UE 115-a (e.g., an aircraft UE 115), may receive the first emergency message and may transmit a first feedback message to the terrestrial UE 115 based on receiving the first emergency message. In some cases, the first feedback message may include an indication that the UE 115-a is available for relaying messages, the UE 115-a is capable of communicating over an ATG wireless communications network, an indication of resources for the second emergency message, or any combination thereof. The terrestrial UE 115 may receive the first feedback message and may unicast the second emergency message to the UE 115-a. The UE 115-a may receive the second emergency message and transmit an indication of an emergency message (e.g., the first emergency message, the second emergency message, or both) to a network entity 105, such as a network entity 105-a. In some cases, the UE 115-a may transmit the indication of the emergency message directly to the network entity 105-a via the communication link 125-a. In some other cases, the UE 115-a may transmit the indication of the emergency message to another UE 115, such as the UE 115-b, for additional relaying. For example, the UE 115-a may transmit the indication of the emergency message to the UE 115-b via a communication link 125-h and the UE 115-b may transmit the indication of the emergency message to the network entity 105-b via the communication link 125-b or to the network entity 105-c via the communication link 125-c.

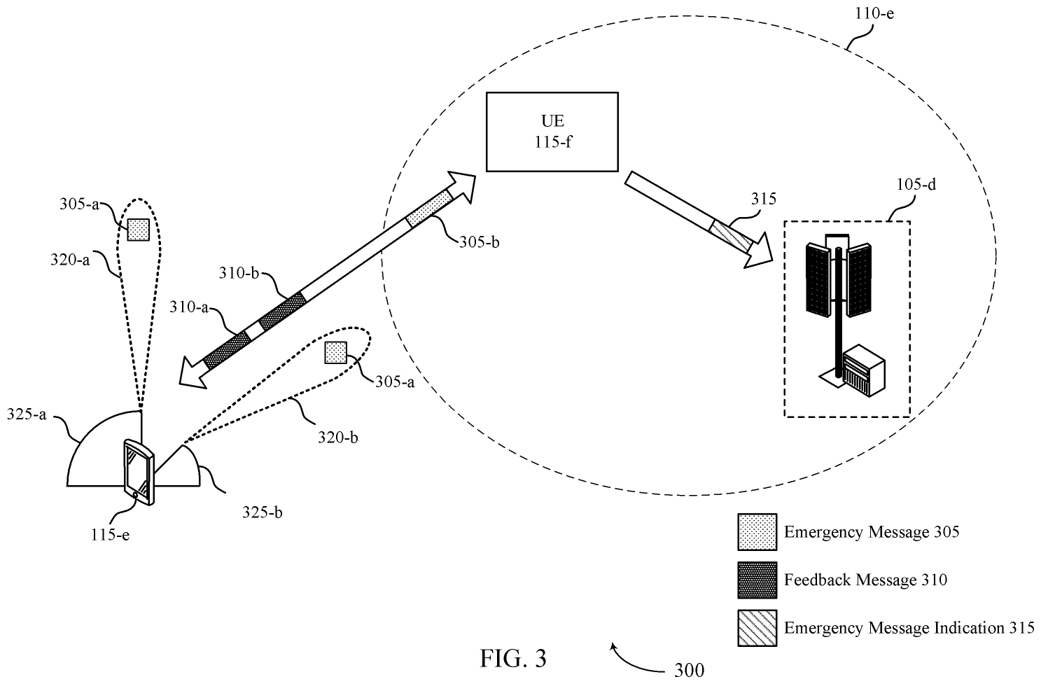

FIG. 3 illustrates an example of a wireless communications system 300 that supports emergency messaging using mobile relay in accordance with one or more aspects of the present disclosure. The wireless communications system 300 may implement or be implemented by aspects of the wireless communications system 100 and the wireless communications system 200. For example, the wireless communications system 300 may include a network entity 105-d, a UE 115-e, and a UE 115-f. The UE 115-e and the UE 115-f may represent examples of UEs 115 as described herein, including with reference to FIG. 1. The network entity 105-d may represent an example of a network entity 105 as described herein, including with reference to FIG. 1. For example, the UE 115-e may transmit emergency messages (e.g., SOS messages) according to the techniques described herein to support interference reduction, power saving, and service enhancements of emergency messaging transmission for the UE 115-e.

Some wireless communications systems may support emergency (e.g., SOS) messaging from a UE 115, such as a terrestrial UE 115. For example, when the terrestrial UE 115 is out of cellular coverage of a network entity 105, the UE 115 may support one or more methods for delivering (e.g., transmitting) emergency messages. In some cases, the terrestrial UE 115 may transmit an emergency message to a satellite entity (e.g., iridium-like message delivery). However, the terrestrial UE 115 may transmit the emergency message based on strict antenna and transmit power parameters (e.g., requirements). As such, the terrestrial UE 115 may successfully transmit the emergency message by pointing one or more antennas at the terrestrial UE 115 towards the satellite entity while transmitting the emergency message to avoid blockage (e.g., which may require skillful human-assisted operations). Additionally, the terrestrial UE 115 may be unable to transmit machine type communications (MTC) based on a form factor of the terrestrial UE 115.

In some cases, the terrestrial UE 115 may transmit an emergency message to a satellite entity using an air interface associated with the satellite entity. However, not all satellite entities may be associated with an air interface and, as such, the terrestrial UE 115 may attempt to transmit an emergency message over the air interface but may be unsuccessful due to lack of coverage from the satellite entity associated with the air interface (e.g., launching satellites associated with air interfaces may be associated with high deployment costs). In other examples, the terrestrial UE may not be capable of transmitting signals at a sufficient power to reach a satellite, which can be longer distance away from the terrestrial UE.

In some cases, the terrestrial UE 115 may transmit an emergency message to an aircraft UE 115 (e.g., to extend coverage for areas without terrestrial network entities 105). Aircraft UEs 115 may cruise at an altitude (e.g., 10 km) which may support LoS propagation for over 200 km (e.g., and there may be at least one aircraft visible within 50-100 km in most major remote areas). Additionally, transmitting an emergency message to an aircraft UE 115 may reduce deployment costs and support decreased human-assistance in operating the terrestrial UE 115 compared to emergency messaging via satellite entities. In some cases, to support emergency messaging, the aircraft UE 115 may constantly broadcast a discovery announcement signal covering a wide area which may cause severe interference towards terrestrial communications (e.g., due to terrestrial communications sharing the same frequency as ATG communications). Additionally, the aircraft UE 115 may be unaware of the existence of the terrestrial UE 115 (e.g., out-of-coverage remote device). In some other cases, the terrestrial UE 115 may transmit repetitions of the emergency message which may result in increased power consumption.

Techniques described herein may support a two-part emergency messaging using mobile relay. In some cases, a UE 115-e (e.g., a terrestrial UE 115) may leave (e.g., go out of range of) a cellular coverage area of a network entity 115 (e.g., a last terrestrial-based network entity 105) and may lose cellular coverage (e.g., become an out-of-cellular-coverage UE 115). In such cases, the UE 115-e may be configured to broadcast (e.g., transmit) a first emergency message (e.g., a first part of a two part emergency message), such as an emergency message 305-a, indicating a request for relaying emergency messages (e.g., when the UE 115-e is out-of-cellular-coverage). As such, the UE 115-e may broadcast (e.g., in a PC5 interface) the emergency message 305-a via a set of broadcast resources. In some cases, the set of broadcast resources may be configured by the last network entity 105 to be in communication with the UE 115-e prior to losing coverage, by a satellite entity (e.g., satellite communication system), or by a set of parameters at the UE 115-e (e.g., preconfigured at the UE 115-e). Additionally, the emergency message 305-a may include an indication of identification for the UE 115-e (e.g., in a dedicated sequence or preamble for emergency messaging). In some cases, the UE 115-e may monitor for a feedback message 310 from a UE 115, such as a UE 115-f, during a period of time (e.g., a configured window) following transmission of the emergency message 305-a.

In some cases, the UE 115-e may broadcast the emergency message 305-a via one or more beams 320, such as a beam 320-a and a beam 320-b, according to a beam sweeping procedure (e.g., scheme). In some examples, the beam sweeping procedure may be a non-uniform beam sweeping procedure. This may be because UEs associated with aircraft may be positioned at different angles from the terrestrial UE than terrestrial-based network entities or other UEs. That is, the UE 115-e may be configured by a last network entity 105 (e.g., via RAN-based signaling or application layer protocols) to transmit the emergency message 305-a according to the non-uniform beam sweeping procedure, where the last network entity 105 is a network entity 105 that the UE 115-e was last (e.g., most recently) communicating with prior to becoming an out-of-cellular-coverage UE 115 (e.g., losing coverage from the last network entity 105).

The non-uniform beam sweeping procedure may include sweeping a beam with low elevation angles (e.g., less than or equal to 18 degrees), such as the beam 320-b with elevation angle 325-b, with high probability and sweeping a beam with high elevation angle (e.g., above 18 degrees), such as the beam 320-a with elevation angle 325-a, with low probability. That is, the UE 115-e may sweep the beam 320-b with elevation angle 325-b with increased repetition compared to the beam 320-a with the elevation angle 325-a. Additionally, a transmit power of beams with low elevation angles may be higher than a transmit power of beams with high elevation angles (e.g., due to aircrafts, such as the aircraft associated with the UE 115-f, typically flying between 6 and 18 degree of elevation angle with 100 km cell radius and an aircraft altitude at 10 km).

In some cases, the UE 115-e may broadcast the emergency message 305-a according to aircraft information (e.g., associated with the UE 115-f). Aircraft information may include information which may enable the UE 115-e to identify one or more UEs 115 (e.g., associated with the aircraft information, such as the UE 115-f), communicate with the one or more UEs 115, determine a location of the one or more UEs 115, determine a direction of the one or more UEs 115, determine a speed of the one or more UEs 115, or the like. For example, the aircraft information may include identification information, location information, flight path information, or any combination thereof.

In some examples, the UE 115-e may be configured to transmit the emergency message 305-a according to the aircraft information based on an indication of the aircraft information included in a control message from the last network entity 105 to be in communication with the UE 115-e prior to losing cellular coverage (e.g., via RAN-based signaling or application layer protocol) or from a satellite entity. In another example, the UE 115-e may be configured to transmit the emergency message 305-a according to the aircraft information based on one or more parameters at the UE 115-e (e.g., the aircraft information may be preconfigured at the UE 115-e). As such, the UE 115-e may monitor for a UE 115 associated with the aircraft information, such as the UE 115-f, and may transmit the emergency message 305-a based on the monitoring. That is, the UE 115-e may broadcast the emergency message 305-a when the UE 115-f is in proximity (e.g., within a distance threshold) of the UE 115-e based on the aircraft information (e.g., the UE 115-f is flying nearby the UE 115-e). Conversely, the UE 115-e may refrain from broadcasting the emergency message 305-a when the UE 115-f is not in proximity of the UE 115-e based on the aircraft information (e.g., the UE 115-g may sleep when the UE 115-f is not in proximity).

In some cases, the UE 115-e may determine that the aircraft information is valid based on one or more positions of the UE 115-e. In other words, the UE 115-e may determine an initial position (e.g., initial global navigation satellite system (GNSS) position) of the UE 115-e (e.g., a position at which the UE 115-e lost coverage) and a current position (e.g., current GNSS position) of the UE 115-e. The initial position of the UE 115-e may be the position of the UE 115-e when the UE 115-e receives the aircraft information (e.g., from the last network entity or from a satellite entity), the position of the UE 115-e when the UE 115-e loses terrestrial cellular coverage, or the like thereof. Further, the UE 115-e may compare the initial position to the current position to determine a change in position (e.g., a distance moved) and compare the change in position to a distance threshold. In some cases, the UE 115-e may determine the aircraft information is valid based on the change in position being less than or equal to (e.g., failing to exceed) the distance threshold. As such, the UE 115-g may transmit the emergency message 305-a according the aircraft information based on the aircraft information being valid. Conversely, the UE 115-e may determine the aircraft information is not valid (e.g., is invalid) based on the change in position being greater than (e.g., exceeding) the distance threshold). As such, the UE 115-g may refrain from transmitting the emergency message 305-a according the aircraft information based on the aircraft information being invalid (e.g., any may transmit the emergency message 305-a according to a periodic timer).

Additionally, or alternatively, the UE 115-e may transmit the emergency message 305-a according to a periodic timer (e.g., when the aircraft information is invalid). For example, the UE 115-e may be configured to transmit the emergency message 305-a according to the periodic timer based on an indication of the periodic timer included in a control message from the last network entity 105 to be in communication with the UE 115-e prior to losing cellular coverage (e.g., via RAN-based signaling or application layer protocol). In some cases, the periodic timer may be used to indicate that the UE-115-g (associated with the aircraft) is listening to particular communication resources for some types of messages, including emergency messages. In some cases, the UE 115-e may broadcast the emergency message 305-a during an “ON” duration and refrain from broadcasting the emergency message 305-b during an “OFF” duration (e.g., the UE 115-g may sleep during the “OFF” duration). The “ON” duration and the “OFF” duration may be based on a periodic “ON” and “OFF” timer for the emergency message 305-a (e.g., indicated in the control message).

The UE 115-f (e.g., relay node) may receive the emergency message 305-a from the UE 115-e. In some cases, the UE 115-f may identify a dedicated emergency message from a specific emergency indication in the emergency message 305-a. Additionally, the UE 115-f may transmit a feedback message 310-a to the UE 115-e based on receiving the emergency message 305-a. In some embodiments, the UE 115-e may refrain from transmitting additional emergency messages 305-a based on receiving the feedback message 310-a (e.g., to reduce power consumption). In some cases, the UE 115-f may be associated with an aircraft (e.g., an aircraft UE 115). In some other cases, the UE 115-f may be a UE 115 (e.g., terrestrial UE 115) that is connected to a network entity, such as the network entity 105-d (e.g., is an in-cellular-coverage UE 115).

In some cases, the UE 115-e may be configured to transmit (e.g., a unicast transmission) a second emergency message (e.g., a second part of a two part emergency message), such as an emergency message 305-b, including emergency information based on receiving the feedback message 310-a. As such, the UE 115-e may transmit (e.g., in a PC5 interface) the emergency message 305-b via a set of unicast resources (e.g., sidelink resources). In some cases, the set of unicast resources may be configured by the last network entity 105 to be in communication with the UE 115-e prior to losing coverage, by a satellite entity (e.g., satellite communication system), by a set of parameters at the UE 115-e, or based on the feedback message 310-a (e.g., an indication in the feedback message 310-a). Additionally, the emergency message 305-b may include an indication of identification for the UE 115-e.

In some cases, the UE 115-f may transmit a feedback message 310-b based on receiving the emergency message 305-b. Additionally, the UE 115-f may transmit (e.g., relay) an emergency message indication 315 to the network entity 105-d, the emergency message indication 315 being based on the emergency message 305-a, the emergency message 305-b, or both. That is, the UE 115-f may relay the emergency message 305-a, the emergency message 305-b, or both, to the network entity 105-d. In some cases, the UE 115-f may transmit the emergency message indication 315 to a satellite entity or another UE 115 (e.g., which may relay the emergency message indication 315 to the network entity 105-d). In some embodiments, the UE 115-e may refrain from broadcasting the emergency message 305-a, unicasting the emergency message 305-b, or both, based on receiving the feedback message 310-b (e.g., from at least one UE 115, such as the UE 115-f).

Though described in the context of a UE 115-f associated with an aircraft, it is understood that the UE 115-f may be any UE 115 (e.g., terrestrial UE 115) that is connect to (e.g., in a coverage area, such as coverage area 110-e) of a network entity 105, such as the network entity 105-d.

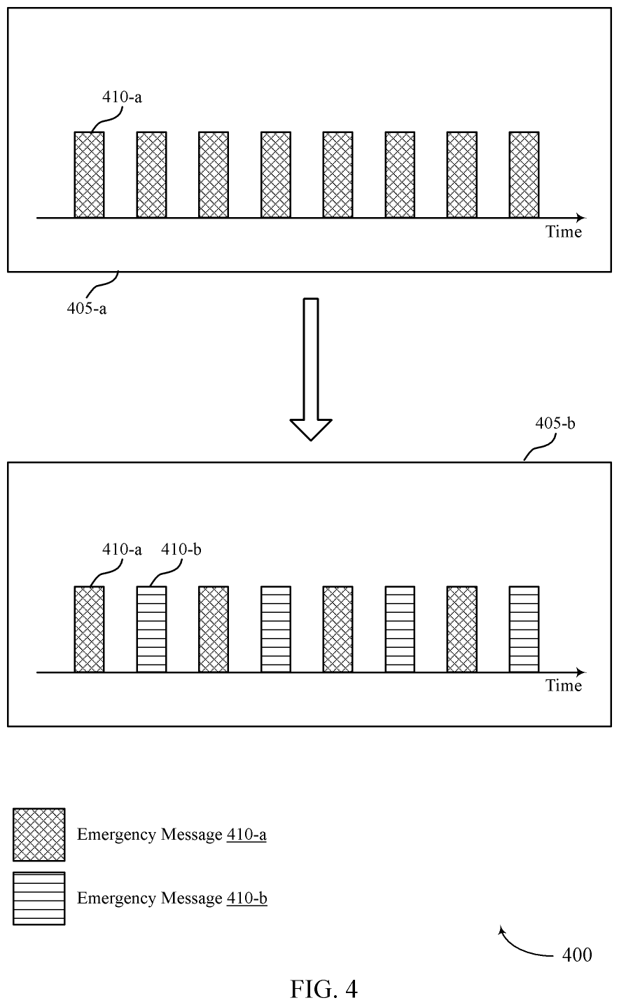

FIG. 4 illustrates an example of cooperative emergency messaging process 400 that supports emergency messaging using mobile relay in accordance with one or more aspects of the present disclosure. The cooperative emergency messaging process 400 may implement or be implemented by aspects of the wireless communications system 100, the wireless communications system 200, and the wireless communication system 300. For example, a first UE 115 and a second UE 115 may perform the cooperative emergency messaging process 400.

A first UE 115 may be out-of-coverage of a network entity and may perform an emergency messaging process according to a timing 405-a as described with reference to FIG. 3. For example, the first UE 115 may transmit (e.g., broadcast) first emergency messages 410-a according to a first periodicity. In some cases, a second UE 115, that is also out-of-coverage of a network entity, may receive a first emergency message 410-a from the first UE 115 and may transmit an indication to the first UE 115 that the second UE 115 received the first emergency message 410-a. Additionally, the second UE 115 may transmit a request to perform the cooperative emergency messaging process 400 according to a timing 405-b (e.g., cooperate with transmitting first emergency messages 410).

In some cases, to perform the cooperative emergency messaging process 400, the first UE 115 may increase a periodicity of transmitting the first emergency messages 410-a with respect to the first periodicity used in the timing 405 (e.g., double the first periodicity) such that the second UE 115 may transmit first emergency messages 410-b between transmissions of the first emergency messages 410-a (e.g., using a time division multiplexing (TDM) manner). That is, the first UE 115 and the second UE 115 may alternate transmitting first emergency messages 410 (e.g., to reduce power consumption of the UEs 115 for longer use).

Though described with respects to a first UE 115 and a second UE 115, it is understood that any quantity of UEs 115 may perform the cooperative emergency messaging process 400. For example, a third UE 115 may perform the cooperative emergency messaging process 400 with the first UE 115 and the second UE 115, such that the UEs 115 alternate transmitting first emergency messages 410.

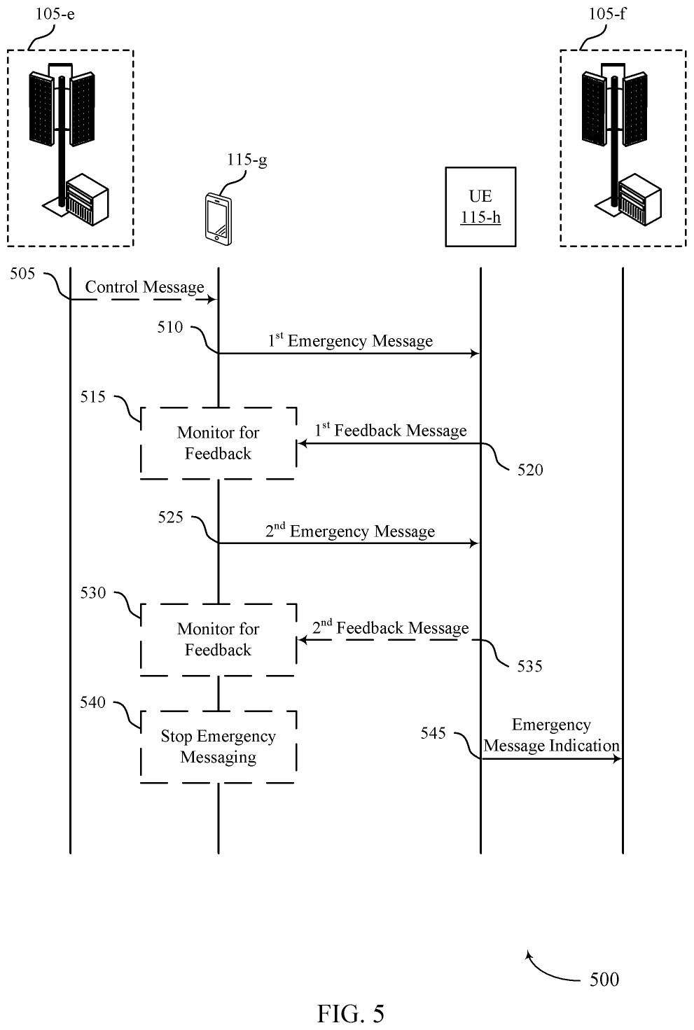

FIG. 5 illustrates an example of a process flow 500 that supports emergency messaging using mobile relay in accordance with one or more aspects of the present disclosure. The process flow 500 may implement or be implemented by aspects of the wireless communications system 100, the wireless communications system 200, the wireless communications system 300, and the cooperative emergency messaging process 400. For example, the process flow 500 may include a network entity 105-e, a network entity 105-f, a UE 115-g, and a UE 115-h. The UE 115-g and the UE 115-h may represent examples of UEs 115 as described herein, including with reference to FIG. 1. The network entity 105-e and the network entity 105-f may represent examples of network entities 105 as described herein, including with reference to FIG. 1. For example, the UE 115-g and the UE 115-h may communicate via a sidelink interface.

In some cases, at 505, the UE 115-g may receive a control message indicating aircraft information (e.g., associated with the UE 115-h). For example, a network entity 105-e may transmit the control message. The network entity 105-e may be an example of a terrestrial-based network entity or a satellite or other non-terrestrial-based network entity. Additionally, or alternatively, the control message may indicate a periodic timer. In some cases, the UE 115-g may leave the coverage area of the network entity 105-e (e.g., after receiving the control message).

At 510, the UE 115-g, which may be out-of-coverage of the network entity 105-e, may transmit a first emergency message indicating a request for relaying a second emergency message to one or more network entities, such as the network entity 105-f. In some cases, the first emergency message may include identification information for the UE 115-g. In some cases, the UE 115-g may transmit the first emergency message according to the aircraft information associated with the UE 115-h. That is, the UE 115-g may compare an initial position of the UE 115-g to a current position of the UE 115-g and determine whether the aircraft information is valid based on a difference between the initial position and the current position satisfying a threshold (e.g., being less than a threshold change in position). Upon determining the aircraft information is valid, the UE 115-g may monitor for the UE 115-h (e.g., associated with the aircraft information) and broadcast the first emergency message when the UE 115-h is within proximity of the UE 115-g. Additionally, or alternatively, the UE 115-g may transmit the first emergency message according to the periodic timer indicated in the control message (e.g., when the UE 115-g determines the aircraft information is invalid based on the difference between the initial position and the current position failing to satisfy the threshold).

In some cases, the UE 115-g may broadcast the first emergency message via one or more beams. Additionally, the UE 115-g may broadcast the first emergency message according to a beam sweeping procedure associated with the one or more beams, where the beam sweeping procedure may be non-uniform. For example, elevation angles of the one or more beams may be configured to communicate with a flying UE (e.g., aircraft UE), such as the UE 115-h. In some cases, the first emergency message may be broadcast (e.g., transmitted) via a set of broadcast resources that is based on one or more parameters at the UE 115-g (e.g., preconfigured at the UE 115-g), the network entity 105-e, a satellite entity, or any combination thereof.

In some cases, the UE 115-g may receive, from an additional UE 115 that is out of coverage of the network entity 105-e, an indication that the additional UE 115 received the first emergency message and a request to cooperate with transmitting emergency messages (e.g., first emergency messages). Additionally, the UE 115-g may transmit the first emergency message according to a periodicity that is based on the request to cooperate with transmitting emergency messages.

In some cases, at 515, the UE 115-g may monitor for a first feedback message in response to the first emergency message. In some cases, the UE 115-g may transmit additional transmissions of the first emergency message based on failing to receive the first feedback message within a time threshold.

At 520, the UE 115-g may receive, from the UE 115-h, the first feedback message in response to the transmitting of the first emergency message. In some cases, the UE 115-h may be associated with an aircraft. In some cases, the first feedback message may indicate that the UE 115-h is in communication with or is capable of communicating with the network entity 105-f via an ATG communication network.

At 525, the UE 115-g may transmit, to the UE 115-h, the second emergency message based on receiving the first feedback message. In some cases, the second emergency message may include identification information for the UE 115-g. In some cases, the second emergency message may be transmitted via a set of broadcast resources that is based on the first feedback message, one or more parameters at the UE 115-g (e.g., preconfigured at the UE 115-g), the network entity 105-e, a satellite entity, or any combination thereof.

In some cases, at 530, the UE 115-g may monitor for a second feedback message in response to the second emergency message. In some cases, the UE 115-g may transmit additional transmissions of the second emergency message based on failing to receive the second feedback message within a time threshold.

In some cases, at 535, the UE 115-g may receive, from the UE 115-h, the second feedback message in response to the second emergency message.

In some cases, at 540, the UE 115-g may refrain from transmitting additional emergency messages (e.g., additional transmissions of the first emergency message, the second emergency message, or both) based on receiving the second feedback message.

At 545, the UE 115-h may transmit an indication over an ATG wireless communications network, the indication based on the first emergency message, the second emergency message, or both.

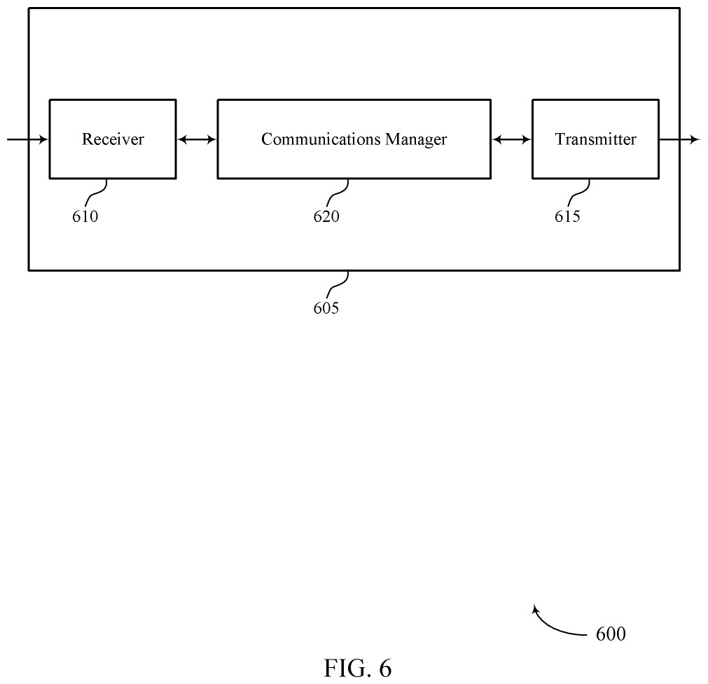

FIG. 6 shows a block diagram 600 of a device 605 that supports emergency messaging using mobile relay in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to emergency messaging using mobile relay). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to emergency messaging using mobile relay). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of emergency messaging using mobile relay as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a first UE in accordance with examples as disclosed herein. For example, the communications manager 620 may be configured as or otherwise support a means for transmitting a first emergency message indicating a request for relaying a second emergency message to one or more network entities, the first UE being out-of-coverage of a network entity. The communications manager 620 may be configured as or otherwise support a means for receiving, from a second UE associated with an aircraft, a feedback message in response to the transmitting of the first emergency message. The communications manager 620 may be configured as or otherwise support a means for transmitting, to the second UE, the second emergency message based on the receiving of the feedback message.

Additionally, or alternatively, the communications manager 620 may support wireless communications at a first UE in accordance with examples as disclosed herein. For example, the communications manager 620 may be configured as or otherwise support a means for receiving, from a second UE, a first emergency message indicating a request for relaying a second emergency message to an entity. The communications manager 620 may be configured as or otherwise support a means for transmitting, to the second UE, a feedback message in response to the receiving of the first emergency message. The communications manager 620 may be configured as or otherwise support a means for receiving, from the second UE, the second emergency message based on the transmitting of the feedback message. The communications manager 620 may be configured as or otherwise support a means for transmitting an indication over an air-to-ground wireless communications network, the indication based on the first emergency message and the second emergency message.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for emergency messaging using mobile relay which may result in reduced processing, reduced power consumption, and more efficient utilization of communication resources, among other advantages.

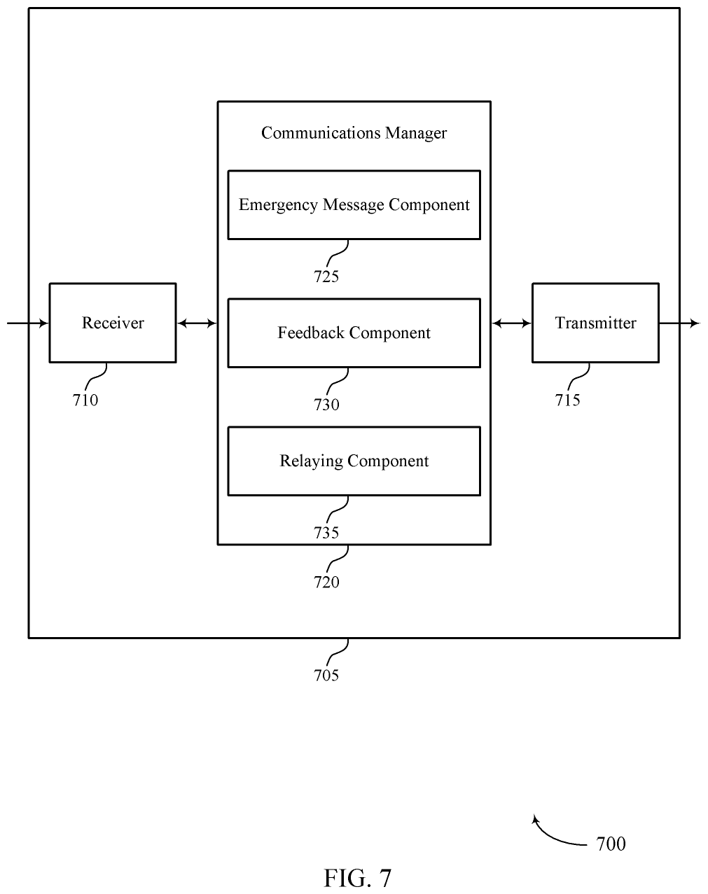

FIG. 7 shows a block diagram 700 of a device 705 that supports emergency messaging using mobile relay in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to emergency messaging using mobile relay). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to emergency messaging using mobile relay). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of emergency messaging using mobile relay as described herein. For example, the communications manager 720 may include an emergency message component 725, a feedback component 730, a relaying component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a first UE in accordance with examples as disclosed herein. The emergency message component 725 may be configured as or otherwise support a means for transmitting a first emergency message indicating a request for relaying a second emergency message to one or more network entities, the first UE being out-of-coverage of a network entity. The feedback component 730 may be configured as or otherwise support a means for receiving, from a second UE associated with an aircraft, a feedback message in response to the transmitting of the first emergency message. The emergency message component 725 may be configured as or otherwise support a means for transmitting, to the second UE, the second emergency message based on the receiving of the feedback message.

Additionally, or alternatively, the communications manager 720 may support wireless communications at a first UE in accordance with examples as disclosed herein. The emergency message component 725 may be configured as or otherwise support a means for receiving, from a second UE, a first emergency message indicating a request for relaying a second emergency message to an entity. The feedback component 730 may be configured as or otherwise support a means for transmitting, to the second UE, a feedback message in response to the receiving of the first emergency message. The emergency message component 725 may be configured as or otherwise support a means for receiving, from the second UE, the second emergency message based on the transmitting of the feedback message. The relaying component 735 may be configured as or otherwise support a means for transmitting an indication over an air-to-ground wireless communications network, the indication based on the first emergency message and the second emergency message.

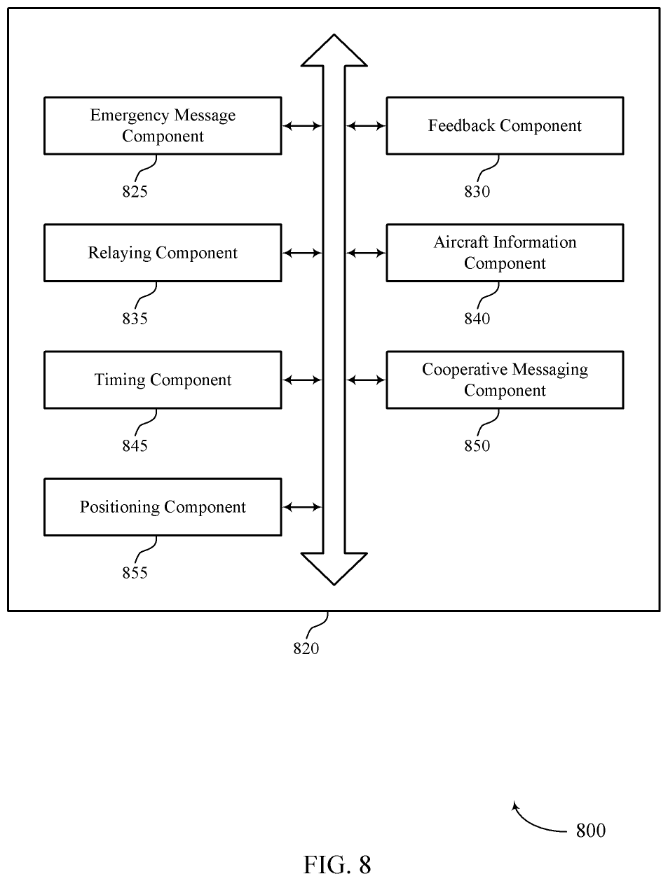

FIG. 8 shows a block diagram 800 of a communications manager 820 that supports emergency messaging using mobile relay in accordance with one or more aspects of the present disclosure. The communications manager 820 may be an example of aspects of a communications manager 620, a communications manager 720, or both, as described herein. The communications manager 820, or various components thereof, may be an example of means for performing various aspects of emergency messaging using mobile relay as described herein. For example, the communications manager 820 may include an emergency message component 825, a feedback component 830, a relaying component 835, an aircraft information component 840, a timing component 845, a cooperative messaging component 850, a positioning component 855, or any combination thereof. Each of these components may communicate, directly or indirectly, with one another (e.g., via one or more buses).

The communications manager 820 may support wireless communications at a first UE in accordance with examples as disclosed herein. The emergency message component 825 may be configured as or otherwise support a means for transmitting a first emergency message indicating a request for relaying a second emergency message to one or more network entities, the first UE being out-of-coverage of a network entity. The feedback component 830 may be configured as or otherwise support a means for receiving, from a second UE associated with an aircraft, a feedback message in response to the transmitting of the first emergency message. In some examples, the emergency message component 825 may be configured as or otherwise support a means for transmitting, to the second UE, the second emergency message based on the receiving of the feedback message.

In some examples, to support receiving of the feedback message, the feedback component 830 may be configured as or otherwise support a means for receiving, in the feedback message, an indication that the second UE is in communication with the network entity via an air-to-ground wireless communications network.

In some examples, to support receiving of the feedback message, the feedback component 830 may be configured as or otherwise support a means for receiving, in the feedback message, an indication that the second UE is capable of communicating with the network entity via an air-to-ground wireless communications network.

In some examples, the feedback component 830 may be configured as or otherwise support a means for receiving, from the second UE, a second feedback message in response to the second emergency message. In some examples, the emergency message component 825 may be configured as or otherwise support a means for refraining from transmitting additional emergency messages based on the receiving of the second feedback message.

In some examples, to support transmitting of the first emergency message, the aircraft information component 840 may be configured as or otherwise support a means for transmitting the first emergency message according to aircraft information associated with the second UE.

In some examples, the positioning component 855 may be configured as or otherwise support a means for comparing an initial position of the first UE to a current position of the first UE. In some examples, the aircraft information component 840 may be configured as or otherwise support a means for determining whether the aircraft information is valid based on a difference between the initial position and the current position satisfying a threshold.

In some examples, the aircraft information component 840 may be configured as or otherwise support a means for receiving, from the network entity, a control message indicating the aircraft information.

In some examples, the timing component 845 may be configured as or otherwise support a means for receiving, from the network entity, a control message indicating a periodic timer, where the transmitting of the first emergency message is based on the periodic timer.

In some examples, to support transmitting the first emergency message, the emergency message component 825 may be configured as or otherwise support a means for broadcasting the first emergency message via one or more beams.

In some examples, a beam sweeping procedure associated with the one or more beams is non-uniform.

In some examples, elevation angles of the one or more beams are configured to communicate with a flying UE.

In some examples, the cooperative messaging component 850 may be configured as or otherwise support a means for receiving, from a third UE that is out-of-coverage of the network entity, an indication that the third UE received the first emergency message and a request to cooperate with transmitting emergency messages, where the transmitting of the first emergency message is based on the receiving of the indication.

In some examples, to support transmitting of the first emergency message, the cooperative messaging component 850 may be configured as or otherwise support a means for transmitting the first emergency message according to a periodicity that is based on the request to cooperate with transmitting emergency messages.

In some examples, the feedback component 830 may be configured as or otherwise support a means for receiving, from a third UE, a second feedback message in response to the transmitting of the first emergency message. In some examples, the emergency message component 825 may be configured as or otherwise support a means for transmitting, to the third UE, the second emergency message based on the receiving of the second feedback message.

In some examples, the first emergency message, the second emergency message, or both, include identification information for the first UE.

In some examples, the first emergency message is transmitted via a set of broadcast resources that is based on one or more parameters at the first UE, the network entity, a satellite entity, or any combination thereof.

In some examples, the second emergency message is transmitted via a set of resources that is based on the feedback message, one or more parameters at the first UE, the network entity, or a satellite entity, or any combination thereof.

In some examples, the first UE communicates with the second UE via a sidelink interface.

Additionally, or alternatively, the communications manager 820 may support wireless communications at a first UE in accordance with examples as disclosed herein. In some examples, the emergency message component 825 may be configured as or otherwise support a means for receiving, from a second UE, a first emergency message indicating a request for relaying a second emergency message to an entity. In some examples, the feedback component 830 may be configured as or otherwise support a means for transmitting, to the second UE, a feedback message in response to the receiving of the first emergency message. In some examples, the emergency message component 825 may be configured as or otherwise support a means for receiving, from the second UE, the second emergency message based on the transmitting of the feedback message. The relaying component 835 may be configured as or otherwise support a means for transmitting an indication over an air-to-ground wireless communications network, the indication based on the first emergency message and the second emergency message.

In some examples, the first UE communicates with the second UE via a sidelink interface.

In some examples, to support receiving the first emergency message, the emergency message component 825 may be configured as or otherwise support a means for receiving the first emergency message in a broadcast transmission.

In some examples, to support transmitting the feedback message, the feedback component 830 may be configured as or otherwise support a means for transmitting, in the feedback message, an indication of resources for transmitting the second emergency message.

In some examples, to support receiving the second emergency message, the emergency message component 825 may be configured as or otherwise support a means for receiving, in the second emergency message, identification information for the second UE.

In some examples, to support receiving the first emergency message, the emergency message component 825 may be configured as or otherwise support a means for receiving the first emergency message via one or more beams.

In some examples, the feedback component 830 may be configured as or otherwise support a means for transmitting a second feedback message in response to the second emergency message.

In some examples, to support transmitting the indication, the relaying component 835 may be configured as or otherwise support a means for transmitting the indication to a network entity, a satellite entity, a third UE, or any combination thereof.

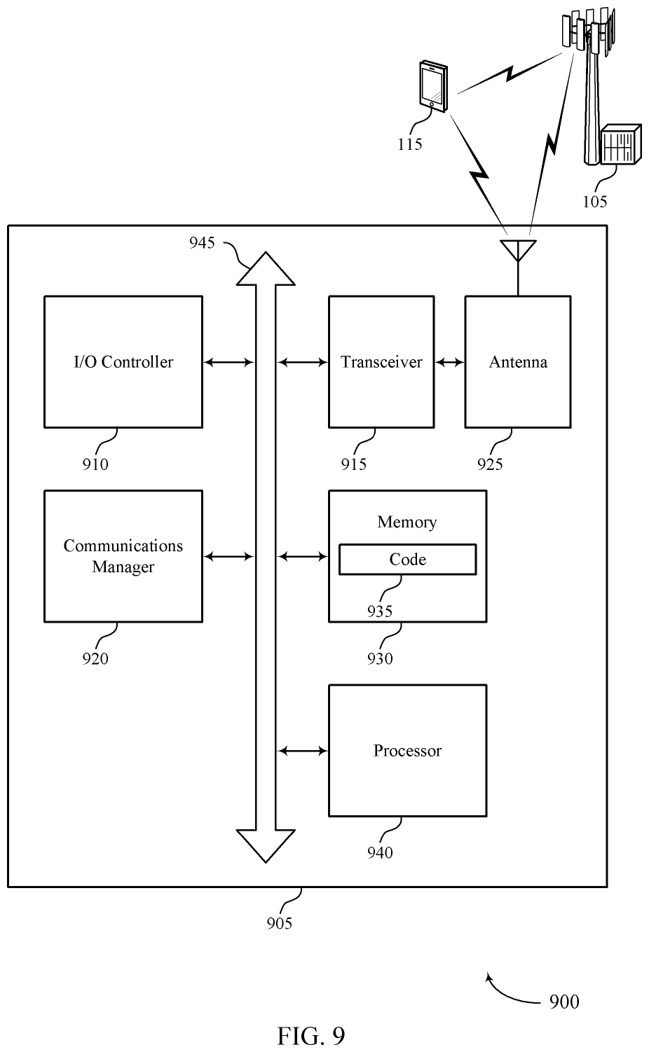

FIG. 9 shows a diagram of a system 900 including a device 905 that supports emergency messaging using mobile relay in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting emergency messaging using mobile relay). For example, the device 905 or a component of the device 905 may include a processor 940 and memory 930 coupled with or to the processor 940, the processor 940 and memory 930 configured to perform various functions described herein.

The communications manager 920 may support wireless communications at a first UE in accordance with examples as disclosed herein. For example, the communications manager 920 may be configured as or otherwise support a means for transmitting a first emergency message indicating a request for relaying a second emergency message to one or more network entities, the first UE being out-of-coverage of a network entity. The communications manager 920 may be configured as or otherwise support a means for receiving, from a second UE associated with an aircraft, a feedback message in response to the transmitting of the first emergency message. The communications manager 920 may be configured as or otherwise support a means for transmitting, to the second UE, the second emergency message based on the receiving of the feedback message.

Additionally, or alternatively, the communications manager 920 may support wireless communications at a first UE in accordance with examples as disclosed herein. For example, the communications manager 920 may be configured as or otherwise support a means for receiving, from a second UE, a first emergency message indicating a request for relaying a second emergency message to an entity. The communications manager 920 may be configured as or otherwise support a means for transmitting, to the second UE, a feedback message in response to the receiving of the first emergency message. The communications manager 920 may be configured as or otherwise support a means for receiving, from the second UE, the second emergency message based on the transmitting of the feedback message. The communications manager 920 may be configured as or otherwise support a means for transmitting an indication over an air-to-ground wireless communications network, the indication based on the first emergency message and the second emergency message.

By including or configuring the communications manager 920 in accordance with examples as described herein, the device 905 may support techniques for emergency messaging using mobile relay which may result in improved communication reliability, reduced latency, improved user experience related to reduced processing, reduced power consumption, more efficient utilization of communication resources, improved coordination between devices, longer battery life, and improved utilization of processing capability, among other advantages

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of emergency messaging using mobile relay as described herein, or the processor 940 and the memory 930 may be otherwise configured to perform or support such operations.

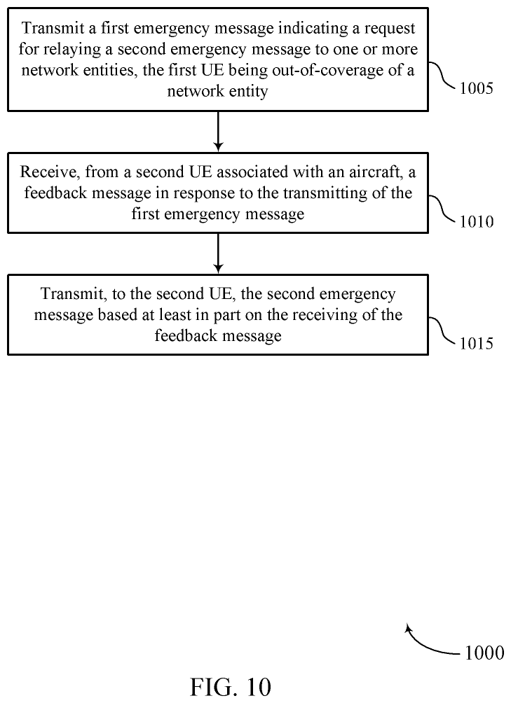

FIG. 10 shows a flowchart illustrating a method 1000 that supports emergency messaging using mobile relay in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include transmitting a first emergency message indicating a request for relaying a second emergency message to one or more network entities, the first UE being out-of-coverage of a network entity. The operations of 1005 may be performed in accordance with examples as disclosed herein. In some examples, aspects of the operations of 1005 may be performed by an emergency message component 825 as described with reference to FIG. 8.

At 1010, the method may include receiving, from a second UE associated with an aircraft, a feedback message in response to the transmitting of the first emergency message. The operations of 1010 may be performed in accordance with examples as disclosed herein. In some examples, aspects of the operations of 1010 may be performed by a feedback component 830 as described with reference to FIG. 8.

At 1015, the method may include transmitting, to the second UE, the second emergency message based on the receiving of the feedback message. The operations of 1015 may be performed in accordance with examples as disclosed herein. In some examples, aspects of the operations of 1015 may be performed by an emergency message component 825 as described with reference to FIG. 8.

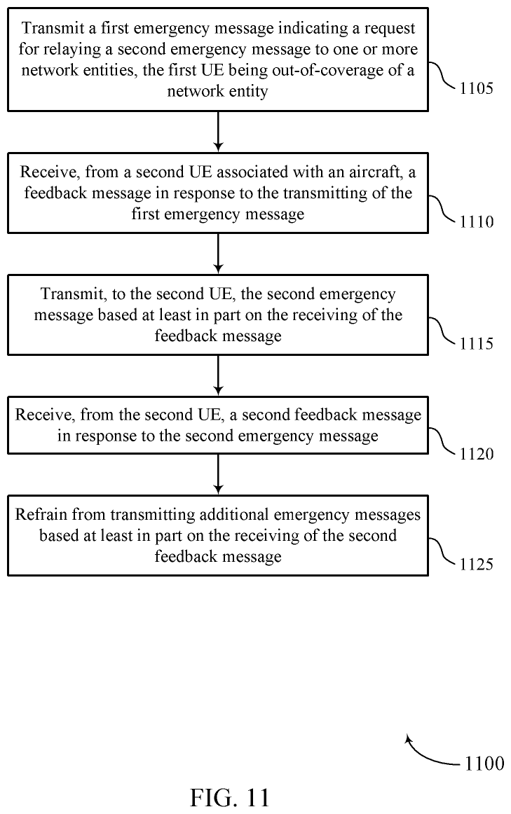

FIG. 11 shows a flowchart illustrating a method 1100 that supports emergency messaging using mobile relay in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include transmitting a first emergency message indicating a request for relaying a second emergency message to one or more network entities, the first UE being out-of-coverage of a network entity. The operations of 1105 may be performed in accordance with examples as disclosed herein. In some examples, aspects of the operations of 1105 may be performed by an emergency message component 825 as described with reference to FIG. 8.

At 1110, the method may include receiving, from a second UE associated with an aircraft, a feedback message in response to the transmitting of the first emergency message. The operations of 1110 may be performed in accordance with examples as disclosed herein. In some examples, aspects of the operations of 1110 may be performed by a feedback component 830 as described with reference to FIG. 8.

At 1115, the method may include transmitting, to the second UE, the second emergency message based on the receiving of the feedback message. The operations of 1115 may be performed in accordance with examples as disclosed herein. In some examples, aspects of the operations of 1115 may be performed by an emergency message component 825 as described with reference to FIG. 8.

At 1120, the method may include receiving, from the second UE, a second feedback message in response to the second emergency message. The operations of 1120 may be performed in accordance with examples as disclosed herein. In some examples, aspects of the operations of 1120 may be performed by a feedback component 830 as described with reference to FIG. 8.

At 1125, the method may include refraining from transmitting additional emergency messages based on the receiving of the second feedback message. The operations of 1125 may be performed in accordance with examples as disclosed herein. In some examples, aspects of the operations of 1125 may be performed by an emergency message component 825 as described with reference to FIG. 8.

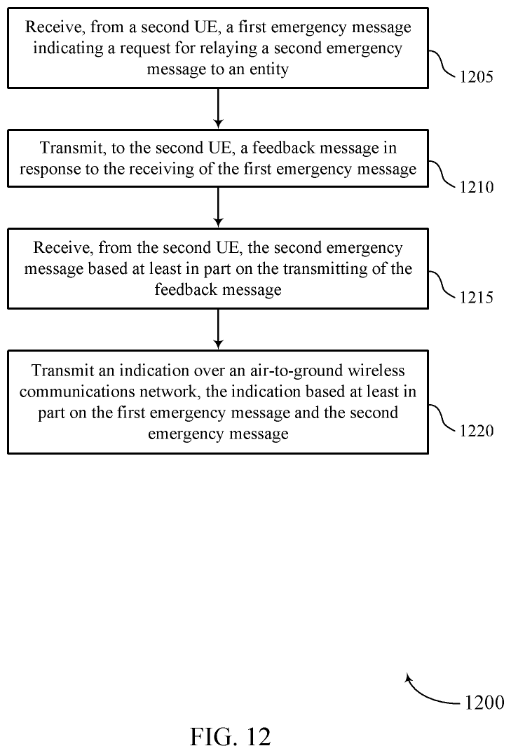

FIG. 12 shows a flowchart illustrating a method 1200 that supports emergency messaging using mobile relay in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include receiving, from a second UE, a first emergency message indicating a request for relaying a second emergency message to an entity. The operations of 1205 may be performed in accordance with examples as disclosed herein. In some examples, aspects of the operations of 1205 may be performed by an emergency message component 825 as described with reference to FIG. 8.

At 1210, the method may include transmitting, to the second UE, a feedback message in response to the receiving of the first emergency message. The operations of 1210 may be performed in accordance with examples as disclosed herein. In some examples, aspects of the operations of 1210 may be performed by a feedback component 830 as described with reference to FIG. 8.

At 1215, the method may include receiving, from the second UE, the second emergency message based on the transmitting of the feedback message. The operations of 1215 may be performed in accordance with examples as disclosed herein. In some examples, aspects of the operations of 1215 may be performed by an emergency message component 825 as described with reference to FIG. 8.

At 1220, the method may include transmitting an indication over an air-to-ground wireless communications network, the indication based on the first emergency message and the second emergency message. The operations of 1220 may be performed in accordance with examples as disclosed herein. In some examples, aspects of the operations of 1220 may be performed by a relaying component 835 as described with reference to FIG. 8.

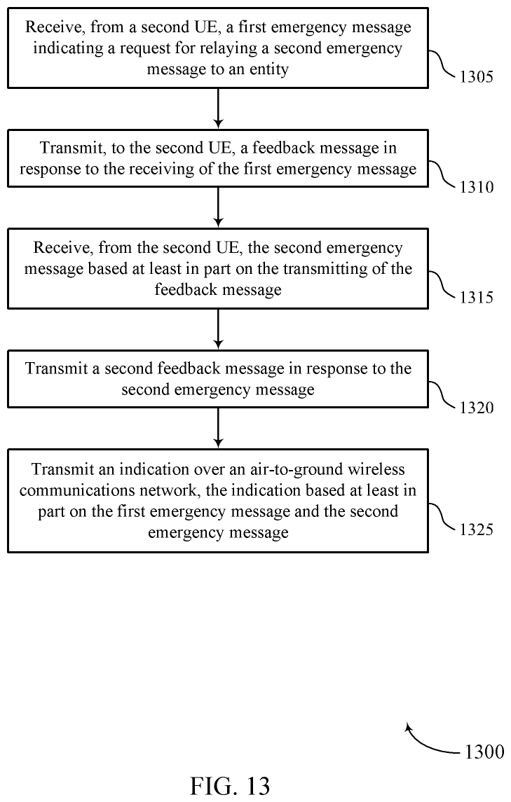

FIG. 13 shows a flowchart illustrating a method 1300 that supports emergency messaging using mobile relay in accordance with one or more aspects of the present disclosure. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1305, the method may include receiving, from a second UE, a first emergency message indicating a request for relaying a second emergency message to an entity. The operations of 1305 may be performed in accordance with examples as disclosed herein. In some examples, aspects of the operations of 1305 may be performed by an emergency message component 825 as described with reference to FIG. 8.

At 1310, the method may include transmitting, to the second UE, a feedback message in response to the receiving of the first emergency message. The operations of 1310 may be performed in accordance with examples as disclosed herein. In some examples, aspects of the operations of 1310 may be performed by a feedback component 830 as described with reference to FIG. 8.

At 1315, the method may include receiving, from the second UE, the second emergency message based on the transmitting of the feedback message. The operations of 1315 may be performed in accordance with examples as disclosed herein. In some examples, aspects of the operations of 1315 may be performed by an emergency message component 825 as described with reference to FIG. 8.

At 1320, the method may include transmitting a second feedback message in response to the second emergency message. The operations of 1320 may be performed in accordance with examples as disclosed herein. In some examples, aspects of the operations of 1320 may be performed by a feedback component 830 as described with reference to FIG. 8.

At 1325, the method may include transmitting an indication over an air-to-ground wireless communications network, the indication based on the first emergency message and the second emergency message. The operations of 1325 may be performed in accordance with examples as disclosed herein. In some examples, aspects of the operations of 1325 may be performed by a relaying component 835 as described with reference to FIG. 8.

The following provides an overview of aspects of the present disclosure:

Aspect 1: A method for wireless communications at a first UE, comprising: transmitting a first emergency message indicating a request for relaying a second emergency message to one or more network entities, the first UE being out-of-coverage of a network entity: receiving, from a second UE associated with an aircraft, a feedback message in response to the transmitting of the first emergency message; and transmitting, to the second UE, the second emergency message based at least in part on the receiving of the feedback message.

Aspect 2: The method of aspect 1, wherein the receiving of the feedback message further comprises: receiving, in the feedback message, an indication that the second UE is in communication with the network entity via an ATG wireless communications network.

Aspect 3: The method of aspects 1, wherein the receiving of the feedback message further comprises: receiving, in the feedback message, an indication that the second UE is capable of communicating with the network entity via an ATG wireless communications network.

Aspect 4: The method of any of aspects 1 through 3, further comprising: receiving, from the second UE, a second feedback message in response to the second emergency message; and refraining from transmitting additional emergency messages based at least in part on the receiving of the second feedback message.

Aspect 5: The method of any of aspects 1 through 4, wherein the transmitting of the first emergency message comprises: transmitting the first emergency message according to aircraft information associated with the second UE.

Aspect 6: The method of aspect 5, further comprising: comparing an initial position of the first UE to a current position of the first UE; and determining whether the aircraft information is valid is based at least in part on a difference between the initial position and the current position satisfying a threshold.

Aspect 7: The method of any of aspects 5 through 6, further comprising: receiving, from the network entity, a control message indicating the aircraft information.

Aspect 8: The method of any of aspects 1 through 7, further comprising: receiving, from the network entity, a control message indicating a periodic timer, wherein the transmitting of the first emergency message is based at least in part on the periodic timer.

Aspect 9: The method of any of aspects 1 through 8, wherein transmitting the first emergency message further comprises: broadcasting the first emergency message via one or more beams.

Aspect 10: The method of aspect 9, wherein a beam sweeping procedure associated with the one or more beams is non-uniform.

Aspect 11: The method of any of aspects 9 through 10, wherein elevation angles of the one or more beams are configured to communicate with a flying UE.

Aspect 12: The method of any of aspects 1 through 11, further comprising: receiving, from a third UE that is out-of-coverage of the network entity, an indication that the third UE received the first emergency message and a request to cooperate with transmitting emergency messages, wherein the transmitting of the first emergency message is based at least in part on the receiving of the indication.

Aspect 13: The method of aspect 12, wherein the transmitting of the first emergency message comprises: transmitting the first emergency message according to a periodicity that is based at least in part on the request to cooperate with transmitting emergency messages.

Aspect 14: The method of any of aspects 1 through 13, further comprising: receiving, from a third UE, a second feedback message in response to the transmitting of the first emergency message; and transmitting, to the third UE, the second emergency message based at least in part on the receiving of the second feedback message.

Aspect 15: The method of any of aspects 1 through 14, wherein the first emergency message, the second emergency message, or both, include identification information for the first UE.

Aspect 16: The method of any of aspects 1 through 15, wherein the first emergency message is transmitted via a set of broadcast resources that is based at least in part on one or more parameters at the first UE, the network entity, a satellite entity, or any combination thereof.

Aspect 17: The method of any of aspects 1 through 16, wherein the second emergency message is transmitted via a set of resources that is based at least in part on the feedback message, one or more parameters at the first UE, the network entity, or a satellite entity, or any combination thereof.

Aspect 18: The method of any of aspects 1 through 17, wherein the first UE communicates with the second UE via a sidelink interface.

Aspect 19: A method for wireless communications at a first UE, comprising: receiving, from a second UE, a first emergency message indicating a request for relaying a second emergency message to an entity: transmitting, to the second UE, a feedback message in response to the receiving of the first emergency message; receiving, from the second UE, the second emergency message based at least in part on the transmitting of the feedback message; and transmitting an indication over an ATG wireless communications network, the indication based at least in part on the first emergency message and the second emergency message.

Aspect 20: The method of aspect 19, wherein the first UE communicates with the second UE via a sidelink interface.

Aspect 21: The method of any of aspects 19 through 20, wherein receiving the first emergency message further comprises: receiving the first emergency message in a broadcast transmission.

Aspect 22: The method of any of aspects 19 through 21, wherein transmitting the feedback message comprises: transmitting, in the feedback message, an indication of resources for transmitting the second emergency message.

Aspect 23: The method of any of aspects 19 through 22, wherein receiving the second emergency message comprises: receiving, in the second emergency message, identification information for the second UE.

Aspect 24: The method of any of aspects 19 through 23, wherein receiving the first emergency message comprises: receiving the first emergency message via one or more beams.

Aspect 25: The method of any of aspects 19 through 24, further comprising: transmitting a second feedback message in response to the second emergency message.

Aspect 26: The method of any of aspects 19 through 25, wherein transmitting the indication comprises: transmitting the indication to a network entity, a satellite entity, a third UE, or any combination thereof.

Aspect 27: An apparatus for wireless communications at a first UE, comprising a processor: memory coupled with the processor; and instructions stored in the memory and executable by the processor to cause the apparatus to perform a method of any of aspects 1 through 18.

Aspect 28: An apparatus for wireless communications at a first UE, comprising at least one means for performing a method of any of aspects 1 through 18.

Aspect 29: A non-transitory computer-readable medium storing code for wireless communications at a first UE, the code comprising instructions executable by a processor to perform a method of any of aspects 1 through 18.

Aspect 30: An apparatus for wireless communications at a first UE, comprising a processor: memory coupled with the processor; and instructions stored in the memory and executable by the processor to cause the apparatus to perform a method of any of aspects 19 through 26.

Aspect 31: An apparatus for wireless communications at a first UE, comprising at least one means for performing a method of any of aspects 19 through 26.

Aspect 32: A non-transitory computer-readable medium storing code for wireless communications at a first UE, the code comprising instructions executable by a processor to perform a method of any of aspects 19 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a first user equipment (UE), comprising:
a processor;
memory coupled with the processor; and
instructions stored in the memory and operable, when executed by the processor, to cause the apparatus to:
transmit a first emergency message indicating a request for relaying a second emergency message to one or more network entities, the first UE being out-of-coverage of a network entity;
receive, from a second UE associated with an aircraft, a feedback message in response to the transmitting of the first emergency message; and
transmit, to the second UE, the second emergency message based at least in part on the receiving of the feedback message.

2. The apparatus of claim 1, wherein the instructions to receive of the feedback message are further executable by the processor to cause the apparatus to:
receive, in the feedback message, an indication that the second UE is in communication with the network entity via an air-to-ground wireless communications network.

3. The apparatus of claim 1, wherein the instructions to receive of the feedback message are further executable by the processor to cause the apparatus to:
receive, in the feedback message, an indication that the second UE is capable of communicating with the network entity via an air-to-ground wireless communications network.

4. The apparatus of claim 1, wherein the instructions are further executable by the processor to cause the apparatus to:
receive, from the second UE, a second feedback message in response to the second emergency message; and
refrain from transmitting additional emergency messages based at least in part on the receiving of the second feedback message.

5. The apparatus of claim 1, wherein the instructions to transmitting of the first emergency message are executable by the processor to cause the apparatus to:
transmit the first emergency message according to aircraft information associated with the second UE.

6. The apparatus of claim 5, wherein the instructions are further executable by the processor to cause the apparatus to:
compare an initial position of the first UE to a current position of the first UE; and
determine whether the aircraft information is valid based at least in part on a difference between the initial position and the current position satisfying a threshold.

7. The apparatus of claim 5, wherein the instructions are further executable by the processor to cause the apparatus to:
receive, from the network entity, a control message indicating the aircraft information.

8. The apparatus of claim 1, wherein the instructions are further executable by the processor to cause the apparatus to:
receive, from the network entity, a control message indicating a periodic timer, wherein the transmitting of the first emergency message is based at least in part on the periodic timer.

9. The apparatus of claim 1, wherein the instructions to transmit the first emergency message are further executable by the processor to cause the apparatus to:
broadcast the first emergency message via one or more beams.

10. The apparatus of claim 9, wherein a beam sweeping procedure associated with the one or more beams is non-uniform.

11. The apparatus of claim 9, wherein elevation angles of the one or more beams are configured to communicate with a flying UE.

12. The apparatus of claim 1, wherein the instructions are further executable by the processor to cause the apparatus to:
receive, from a third UE that is out-of-coverage of the network entity, an indication that the third UE received the first emergency message and a request to cooperate with transmitting emergency messages, wherein the transmitting of the first emergency message is based at least in part on the receiving of the indication.

13. The apparatus of claim 12, wherein the instructions to transmitting of the first emergency message are executable by the processor to cause the apparatus to:
transmit the first emergency message according to a periodicity that is based at least in part on the request to cooperate with transmitting emergency messages.

14. The apparatus of claim 1, wherein the instructions are further executable by the processor to cause the apparatus to:
receive, from a third UE, a second feedback message in response to the transmitting of the first emergency message; and
transmit, to the third UE, the second emergency message based at least in part on the receiving of the second feedback message.

15. The apparatus of claim 1, wherein the first emergency message, the second emergency message, or both, include identification information for the first UE.

16. The apparatus of claim 1, wherein the first emergency message is transmitted via a set of broadcast resources that is based at least in part on one or more parameters at the first UE, the network entity, a satellite entity, or any combination thereof.

17. The apparatus of claim 1, wherein the second emergency message is transmitted via a set of resources that is based at least in part on the feedback message, one or more parameters at the first UE, the network entity, or a satellite entity, or any combination thereof.

18. The apparatus of claim 1, wherein the first UE communicates with the second UE via a sidelink interface.

19. An apparatus for wireless communications at a first user equipment (UE), comprising:
a processor;
memory coupled with the processor; and
instructions stored in the memory and operable, when executed by the processor, to cause the apparatus to:
receive, from a second UE, a first emergency message indicating a request for relaying a second emergency message to an entity;
transmit, to the second UE, a feedback message in response to the receiving of the first emergency message;
receive, from the second UE, the second emergency message based at least in part on the transmitting of the feedback message; and
transmit an indication over an air-to-ground wireless communications network, the indication based at least in part on the first emergency message and the second emergency message.

20. The apparatus of claim 19, wherein the first UE communicates with the second UE via a sidelink interface.

21. The apparatus of claim 19, wherein the instructions to receive the first emergency message are further executable by the processor to cause the apparatus to:
receive the first emergency message in a broadcast transmission.

22. The apparatus of claim 19, wherein the instructions to transmit the feedback message are executable by the processor to cause the apparatus to:
transmit, in the feedback message, an indication of resources for transmitting the second emergency message.

23. The apparatus of claim 19, wherein the instructions to receive the second emergency message are executable by the processor to cause the apparatus to:
receive, in the second emergency message, identification information for the second UE.

24. The apparatus of claim 19, wherein the instructions to receive the first emergency message are executable by the processor to cause the apparatus to:
receive the first emergency message via one or more beams.

25. The apparatus of claim 19, wherein the instructions are further executable by the processor to cause the apparatus to:
transmit a second feedback message in response to the second emergency message.

26. The apparatus of claim 19, wherein the instructions to transmit the indication are executable by the processor to cause the apparatus to:
transmit the indication to a network entity, a satellite entity, a third UE, or any combination thereof.

27. A method for wireless communications at a first user equipment (UE), comprising:
transmitting a first emergency message indicating a request for relaying a second emergency message to one or more network entities, the first UE being out-of-coverage of a network entity;
receiving, from a second UE associated with an aircraft, a feedback message in response to the transmitting of the first emergency message; and
transmitting, to the second UE, the second emergency message based at least in part on the receiving of the feedback message.

28. The method of claim 27, wherein the receiving of the feedback message further comprises:
receiving, in the feedback message, an indication that the second UE is in communication with the network entity via an air-to-ground wireless communications network.

29. The method of claim 27, further comprising:
receiving, from the second UE, a second feedback message in response to the second emergency message; and
refraining from transmitting additional emergency messages based at least in part on the receiving of the second feedback message.

30. A method for wireless communications at a first user equipment (UE), comprising:
receiving, from a second UE, a first emergency message indicating a request for relaying a second emergency message to an entity;
transmitting, to the second UE, a feedback message in response to the receiving of the first emergency message;
receiving, from the second UE, the second emergency message based at least in part on the transmitting of the feedback message; and
transmitting an indication over an air-to-ground wireless communications network, the indication based at least in part on the first emergency message and the second emergency message.
